(19) United States
(12) Patent Application Publication
(10) Pub. No.: US 2009/0225925 A1
(43) Pub. Date: Sep. 10, 2009

(54) FUEL ASSEMBLY LOADING MACHINE AND METHOD FOR HANDLING FUEL ASSEMBLIES

(75) Inventors: Jurgen Eisner, Maintal (DE); Holger Weimer, Puschendorf (DE); Edgar Bott, Alzenau (DE)

Correspondence Address: LERNER GREENBERG STEMER LLP, P O BOX 2480, HOLLYWOOD, FL, 33022-2480, US

(73) Assignee: Areva NP GmbH, Erlangen (DE)

(21) Appl. No.: 12/359,689

(22) Filed: Jan. 26, 2009

Related U.S. Application Data
(63) Continuation of application No. PCT/EP2007/006471, filed on Jul. 20, 2007.

(30) Foreign Application Priority Data
Jul. 24, 2006 (DE) 10 2006 034 680.7

(51) Int. Cl. G21C 19/00

(52) U.S. Cl. 376/261

(57) ABSTRACT

To permit the particularly safe, easy handling of fuel elements, the fuel element loading machine with a lifting apparatus has a guide mast and a fuel element gripper which can be extended telescopically from the guide mast. A video camera is for this purpose arranged on the lifting apparatus, is connected on the data side to a control station and has its viewing direction pointed downwards.

### CROSS-REFERENCE TO RELATED APPLICATION

This is a continuing application, under 35 U.S.C. § 120, of copending international application No. PCT/EP2007/006471, filed Jul. 20, 2007, which designated the United States; this application also claims the priority, under 35 U.S.C. § 119, of German patent application No. DE 10 2006 034 680.7, filed Jul. 24, 2006; the prior applications are herewith incorporated by reference in their entirety.

### BACKGROUND OF THE INVENTION

### Field of the Invention

The invention relates to a fuel assembly loading machine with a lifting apparatus which comprises a guide mast and a fuel assembly gripper that can be extended telescopically from the guide mast. The fuel assembly gripper has a gripping apparatus at the lower end and the guide mast is anchored on a traveling trolley that can move on a horizontal plane. The invention furthermore relates to a method for handling fuel assemblies in a nuclear power station using such a fuel assembly loading machine.

Fuel assembly loading machines, or loading machines for short, are preferably located in the containment or in the fuel assembly building of a nuclear engineering plant, for example in a pressurized-water or a boiling-water reactor plant. The loading machine is usually used to transport fuel assemblies between the reactor of the plant and a fuel assembly storage pool. In the case of a fuel assembly exchange, the spent fuel assemblies are transported from the reactor into the storage pool, and at the same time new fuel assemblies are fitted in the reactor. The loading machine can also be used to move or manipulate fuel assemblies inside the reactor. The sequence of such handling steps is generally carried out, recorded and checked a number of times according to a step sequence plan which is determined in advance.

The loading machine is generally in the form of a crane-type lifting apparatus fixed to a traveling trolley which can move along a traveling bridge. The traveling bridge itself can usually move along rails in a direction which is horizontal and perpendicular to its longitudinal direction, and the traveling trolley with the lifting apparatus can therefore be positioned as desired on a geodetically horizontal plane inside a region of action, which is defined by the dimensions of the traveling bridge and the extent of the rail path. The lifting apparatus comprises a guide mast which is anchored at its upper end to the traveling trolley, and a fuel assembly gripper which can be extended downward telescopically from the guide mast. The fuel assembly gripper has at its lower end a gripping apparatus with a number of gripping latches for use in the actual gripping procedure. In particular in pressurized-water reactors, the fuel assembly gripper can also be in the form of a so-called double gripper, which is used, at the same time or as an alternative to handling the entire fuel assembly, to manipulate and move a control rod arranged in the fuel assembly or a restrictor body inserted into the control rod guide tubes. Also provided between the fuel assembly gripper and the guide mast may be a so-called centering bell as a further telescope element.

In order to store and hold the fuel assemblies, usually a storage rack is arranged in the storage pool. The fuel assemblies, which have an elongate shape, are in each case arranged inside such a storage rack in an operating or storage position which is currently assigned to them. In this case, the fuel assemblies are oriented in the geodetically vertical direction, that is to say upright. The fuel assemblies are close together and upright next to one another in the reactor pool of a pressurized-water reactor, too, but generally without upper guide or the like. From a vertical viewing direction from above, the fuel assemblies thus form a chessboard-type or lattice-type pattern, wherein the position of each of the fuel assemblies can be characterized by two coordinates in a two-dimensional, horizontally orientated coordinate system. A particularly expedient coordinate system in this respect has a coordinate axis which is orientated in the direction of extent of the traveling bridge and a coordinate axis which is perpendicular thereto, that is in the direction of the rail path for the traveling bridge.

If the aim is to pick up a fuel assembly positioned in the reactor pool of the reactor using the loading machine and transport it to the storage pool, for example for a fuel assembly exchange, the traveling trolley with the lifting apparatus arranged thereon is firstly moved to a reference position which corresponds to the position of the fuel assembly. The positional data of the fuel assembly necessary for this are usually stored in a control stand of the loading machine. The current position of traveling trolley and/or traveling bridge is detected by means of a path measurement and compared to the respective absolute value specification, with the result that this first step of the pickup and transport procedure can be effected in an automated manner by appropriately controlling the drive units of traveling trolley and traveling bridge. Thereafter, the fuel assembly gripper is extended downward in order to grip the fuel assembly using the gripping apparatus arranged on its lower end. In the process, however, temporal delays may occur in particular as a result of fuel assemblies which are at an angle in the reactor pool or in the storage pool.

Although gripping latches are usually arranged on the fuel assembly gripper and centering pins on the centering bell, which jostle a fuel assembly which might be at a slight angle into the position necessary for latching in the fuel assembly grippers and gripping latches, generally the lifting apparatus needs to be repositioned manually, that is to say the traveling trolley and/or traveling bridge need to be realigned, if positional deviations exceed the tolerances which are permitted by the construction. Since the centering and gripping procedures typically take place, for radiation-engineering reasons, several meters underneath the water surface of the reactor pool or storage pool, and the visible region is severely limited by the guide mast and the centering bell, it is difficult or even completely impossible to visually monitor procedures from the loading machine or from the pool edge. This only leaves a comparatively complex repositioning on the basis of the “trial and error” principle. Since such a procedure does not completely exclude handling errors, such as gripping and moving the “wrong” fuel assembly, the identifier of which does not correspond to the identifier defined in the step sequence plan, a subsequent check of the new loading is additionally necessary.

At present, delay times of up to 10 hours occur in the case of a periodic fuel assembly exchange during loading and unloading, when typically approximately 400 driving and repositioning procedures are carried out, due to the above-described handling difficulties. During the fuel assembly exchange, the reactor is turned off. In order to keep the production loss of produced power during the fuel assembly exchange as low as possible, the aim is to carry out the fuel assembly exchange within as short a period of time as possible.

### SUMMARY OF THE INVENTION

It is accordingly an object of the invention to provide a fuel assembly loading machine and a method for handling fuel assemblies using a loading machine of the type, which overcomes the above-mentioned disadvantages of the heretofore-known devices and methods of this general type and which achieves a decrease in the time necessary to exchange a fuel assembly, compared to conventional technology, while at the same time increasing handling safety.

With the foregoing and other objects in view there is provided, in accordance with the invention, a fuel assembly loading machine, comprising:

a traveling trolley movable about a substantially horizontal plane;

a lifting apparatus including a guide mast anchored to the traveling trolley and a fuel assembly gripper mounted to be extended telescopically from the guide mast;

the fuel assembly gripper being a double gripper having a gripping apparatus at a lower end thereof and a control rod gripper carried in an interior thereof;

a video camera mounted to the fuel assembly gripper, the video camera having an objective lens pointed in a downward viewing direction and being connected in terms of data to a control stand; and

an endoscope disposed between the objective lens of the video camera and the lower end of the fuel assembly gripper; and

an internal tube encasing the video camera and the endoscope and illumination means in a water-tight manner; and

a protective guide tube configured to receive the internal tube for insertion from above.

In other words, the objects of the invention are achieved in that a video camera, the viewing direction of which is pointed downward and which is connected in terms of data to a control stand, is arranged on the lifting apparatus.

Here, the invention proceeds from the assumption that the aim is to monitor the handling of fuel assemblies using the fuel assembly loading machine in as real time and continuous a fashion as possible, so that handling errors and complicated positional corrections on the basis of the “trial and error” principle are avoided right from the outset or are at least restricted to a minimum. In addition to the status displays which are provided by the loading machine itself and/or measuring data provided for example by load sensors or the like, provision should also expediently be made to directly monitor the gripping region visually. To this end, according to the concept provided herein, a video camera is pointed at the positioning procedure of the gripper system, with the image or video signals of the video camera representing the current state in the reactor core or in the storage pool. The video signals are transmitted in analog or digital form to a control stand. The control stand can in particular also be arranged on the reactor operating plane, with the result that the operating and monitoring staff are not exposed to any noteworthy level of radiation. The video signals can, for example, also be stored or archived on a magnetic strip or on a bulk memory in an electronic data processing system for later evaluation or for documentation purposes. In order to avoid light refraction at the water surface, which interferes with the image evaluation, the video camera should moreover be arranged underneath the water surface. Since the position of the fuel assembly gripper relative to the upper end of the respective fuel assembly is primarily of interest for the safe handling of the fuel assemblies and the exact alignment of traveling trolley and traveling bridge, wherein the two-dimensional, horizontal coordinate system mentioned in the introduction is used as a basis for determining the position, the viewing direction of the camera should substantially be pointed downward onto the fuel assembly which is chosen in each case for a quick and meaningful detection of deviations. The region the camera can see should in this case be restricted as little as possible by the lifting apparatus itself and in particular by any centering bell which may be present. For this reason, the camera should be expediently integrated directly in the telescope elements of the lifting apparatus, which can be extended downward. For a constant distance from the gripping region, the video camera is advantageously arranged on the fuel assembly gripper. This avoids frequent refocusing of the video camera.

For ascertaining necessary positional corrections due to fuel assemblies which are at an angle, it is in principle sufficient for the viewing direction of the video camera to point substantially perpendicularly downward. However, the field of vision of the video camera advantageously encloses here also at least partially the gripping latches of the gripping apparatus and/or the centering pegs of the centering bell. In this way it is possible on the one hand to monitor directly the operational reliability of the gripping latches arranged on the fuel assembly gripper or of the centering pins or pegs arranged on the centering bell. On the other hand it is possible in this way to quickly detect any foreign bodies in the gripping region, too, which could obstruct the handling process.

In an advantageous development, the video camera comprises a converter unit which is physically separate from a recording optics. The converter unit which may under certain circumstances have radiation-sensitive electronic devices is preferably arranged at the upper end of the fuel assembly gripper, whilst the recording optics is preferably arranged at the lower part of the fuel assembly gripper. As an alternative or supplement to such an embodiment, an endoscope is advantageously arranged between the objective lens of the video camera and the lower end of the fuel assembly gripper. It is possible in this embodiment for the distance of the video camera or at least its radiation-sensitive components from the comparatively strongly radioactive fuel assembly to be relatively large and still achieve an advantageous image detail through the endoscope, which in a way extends the objective lens of the camera downward.

Advantageously, the endoscope is in the form of a rigid endoscope, in particular of a glass endoscope with a lens optics. Such a glass endoscope is particularly resistant to radiation and therefore needs to be exchanged only comparatively rarely. Alternatively, however, a comparatively cost-effective flexible endoscope with a flexible optical waveguide, for example made of a fiberglass material or the like, or a correspondingly small tube camera can also be used.

In another advantageous embodiment, luminous means for lighting the gripping region enclosing the centering and gripping apparatus are arranged on the fuel assembly gripper. In this way, a clear and defined video image can be obtained even in the case of slower-lens video cameras and/or several meters underneath the water level of the reactor pool. The luminous means can advantageously also be integrated in the endoscope.

The video camera and the endoscope and, if appropriate, the luminous means are advantageously enclosed by a protective and guide tube and are thus largely protected against external mechanical action, for example by possible collisions with the fuel assembly storage rack or other internal fittings in the reactor pool or storage pool. In one advantageous and space-saving embodiment which is matched to the narrow spatial conditions inside the lifting apparatus which can extend like a telescope, the protective and guide tube is fixed to the outside of the fuel assembly gripper. In the case of a fuel assembly gripper with rectangular cross section, the protective and guide tube can in particular be arranged in one of the corner regions. When the fuel assembly griper is inserted into the guide mast which is in the form of a hollow body, the protective tube is thus also pulled into the guide mast. In order to protect the video camera and/or the endoscope, they are advantageously accommodated in an internal tube which is closed on both ends in a water-tight manner, wherein the internal tube and the internal diameter of the protective and guide tube are expediently matched to one another exactly such that the internal tube, during installation of the entire system, can be inserted into the protective and guide tube from its comparatively easily accessible upper end and then be pushed in a self-centering manner into its operating position. Exact alignment of the video camera is therefore ensured. The internal tube can be also exchanged comparatively easily together with the video camera and the endoscope as needed, for example for maintenance purposes. In order to fix the internal tube in its operating position, fixing or clamping means are preferably provided, which can be accessed from the upper end of the protective and guide tube. It can be fixed, for example, by way of an intermediate piece with the appropriate length, which extends between the upper end of the internal tube and an upper closure cap which is placed onto the protective and guide tube and is locked there.

For exchanging the nuclear fuel, generally the individual fuel assemblies in their entirety in each case are exchanged. A so-called double gripper is used in particular in pressurized-water reactors for handling fuel assemblies and control rods and restrictor bodies. Said double gripper is fitted with an automatically operable control rod gripper and an automatically operable fuel assembly gripper, with the result that it is possible both to transport and move a control rod and a fuel assembly each alone and to jointly handle the fuel assembly together with the control rod still located therein. The control rod gripper is usually guided inside the fuel assembly gripper.

In an additional or alternative advantageous embodiment, a centering bell forming another telescope element can be provided between the guide mast and the fuel assembly gripper.

Preferably, the control stand of the loading machine comprises a display monitor for the display of the video signals transmitted by the video camera, so that, when the loading machine is controlled manually in real time (“live”), the loading machine operator gains an insight into the gripping region of the lifting apparatus and into the fuel assemblies located hereunder and can make any necessary corrections with particular precision due to said additional visual information. It is also possible to detect, using the video image, an identification feature affixed at the upper top fitting region of the respective fuel assembly, for example a fuel assembly identification number, even before the fuel assembly is gripped and to compare it to the specification noted in a step sequence plan. In this way, loading control is effected even before or during the actual loading process. In this manner, the time-consuming check after the loading process can be omitted and the downtime of the nuclear reactor during the fuel assembly exchange is significantly decreased overall. A (redundant) loading control can of course also take place after the loading process using the video data.

The control stand of the loading machine advantageously comprises an electronic data processing system which is adapted and configured for the evaluation and processing of the video data transmitted by the video camera. To this end, the data processing system is expediently equipped with an image processing module which can be stored in a memory unit, for example in the form of a software program which can run on the processor of the data processing system, or can be permanently programmed into the data processing system. Such a software program for image processing or image analysis (Image Processing Software) advantageously evaluates the camera image automatically, in the process detects possible positional deviations of the loading machine or of the respective fuel assembly and calculates necessary corrections. On the data output side, the image processing module is advantageously connected to a control module for the traveling trolley and/or the traveling bridge. The control module converts the correction instructions ascertained by the image processing module into absolute coordinates and transmits them to a manipulated variable sensor for the drive units of the loading machine such that completely automatic control or repositioning of the same is possible. The loading machine operator can observe the automated loading process on a display monitor and switch to manual operation as needed.

In a particularly advantageous embodiment, the data processing module comprises a pattern recognition module, which can be used to recognize and identify identification features affixed to the respective fuel assembly likewise in an automated manner. By way of example, so-called OCR software (OCR=Optical Character Recognition) can be used for identifying a fuel assembly identification number or a corresponding bar code marking or the like. In this case, the pattern recognition module preferably communicates with the control module and/or with an administration module for the fuel assemblies, which can also be part of a further, external data processing system. Handling errors, such as moving a fuel assembly, the fuel assembly identification number of which does not correspond to the specification of the step sequence plan, are recognized automatically and displayed to the operating staff of the loading machine. In such a case, the drive of the loading machine or of the fuel assembly gripper can also be automatically blocked and operation be interrupted, even before a “wrong” fuel assembly is gripped or moved.

As regards the method, the stated object is achieved by monitoring in real time the loading process and/or the unloading process using the video signals transmitted by the video camera. Advantageously, the image data transmitted by the video camera are used here to ascertain the current state of one or more fuel assemblies and if appropriate a deviation from the respective predetermined state, and then the position of the traveling trolley relative to a fixedly defined reference position which is matched to the predetermined state is corrected. Preferably, such corrections are automated by analyzing the video signals transmitted by the video camera by way of an image processing module of an electronic data processing system and feeding the state variables ascertained in the process to a control module for the loading machine.

In a particularly preferred development of the method, the respective fuel assembly is identified using the video signals transmitted by the video camera before or during the gripping process, wherein for example a fuel assembly identification number affixed to the fuel assembly or a corresponding bar code or the like can be used as the identification feature. Advantageously, the identification is effected automatically by a pattern recognition module of the electronic data processing system, wherein the current position of the fuel assembly thus identified is compared to the predetermined specification of a step sequence plan stored in an administration module.

In an analogous manner, for example control elements, control rods or restrictor bodies, in addition to the fuel assemblies, can also be provided with corresponding identifiers or identification features which likewise can be visually detected via the video signals of the gripper camera and, if appropriate, be automatically evaluated and processed via pattern recognition software.

The advantages achieved by the invention are in particular that visual “online” monitoring of the handling and loading processes in the reactor pool or storage pool of a nuclear engineering plant is made possible by way of the integration of a camera system in the existing structure of the fuel assembly gripper of a fuel assembly loading machine. The improved handling of the fuel assemblies ensures increased operational reliability. Loading errors and handling times are minimized. The embodiment described, in which the video camera is integrated together with an endoscope in a protective tube, is very compact and is also suitable for retrofitting existing plants. The camera unit can also, if appropriate, easily be exchanged. In newly developed loading machines, owing to the improved handling options, a hitherto conventional centering bell can possibly be dispensed with, as a result of which the gripper construction is simplified.

The image date transmitted by the video camera can finally also be processed by an electronic image processing system and/or pattern recognition system and be used to control or regulate the loading machine, as a result of which a completely automated driving of the loading machine is made possible.

Moreover, the camera system can also advantageously be used extremely generally in inspection, maintenance and recovery processes, for example during the observation of internal fittings in the reactor pool or storage pool or during localization and removal of foreign bodies.

By way of example, depending on the reactor type and application, it is also possible to use the transmitted video images to identify damage to the top fitting of fuel assemblies, control elements, control rods or restrictor bodies early, so that appropriate countermeasures can be taken in a purposeful manner, which countermeasures are in turn supported by the visual information of the camera system, if appropriate.

Other features which are considered as characteristic for the invention are set forth in the appended claims.

Although the invention is illustrated and described herein as embodied in a fuel assembly loading machine and method for handling fuel assemblies, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic detail illustration of a fuel assembly loading machine having a video camera which is integrated in a fuel assembly gripper and is connected on the data output side with a display monitor and with an electronic data processing system; and

FIG. 2 shows a protective and guide tube for the protected accommodation of the video camera.

### DETAILED DESCRIPTION OF THE INVENTION

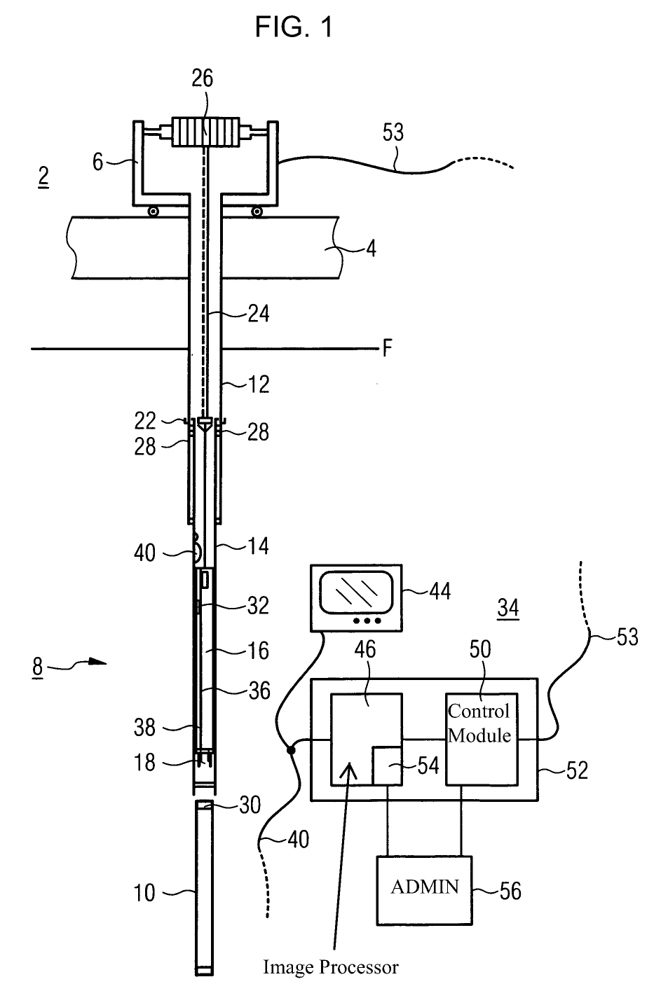

Referring now to the figures of the drawing, in which identical parts have the same reference symbols in all the figures, and first, particularly, to FIG. 1 thereof, the schematic illustration shows a detail from a fuel assembly loading machine 2 (in short: loading machine). The loading machine 2 has a moveable traveling bridge 4 which is mounted in a reactor building (not shown here) of a nuclear engineering plant. The traveling bridge 4 can be moved by way of a drive apparatus perpendicular to the figure plane. A traveling trolley 6, which can be moved by means of another drive apparatus geodetically horizontally at right angles with respect to the traveling bridge 4, is located on the traveling bridge 4. The two directions of travel here define a right-angled, horizontal coordinate system in which the current position of the traveling trolley 6 is defined by two coordinates.

The traveling trolley 6 has on its lower side a lifting apparatus 8 for fuel assemblies 10, which can extend downward like a telescope. Provided as telescope elements are in this case a guide mast 12, anchored on the traveling trolley 6, a centering bell 14 and a double gripper, comprising a fuel assembly gripper 16 and a control rod gripper. A gripping apparatus 18 for gripping a fuel assembly 10 is disposed at the lower end of the fuel assembly gripper 16. In addition, a control rod gripper (not illustrated in greater detail here) which, independently of the other telescope elements, can be moved upward and downward and which enables the accommodation or manipulation of a control element, inserted in a fuel assembly 10, or of a restrictor body is guided inside the fuel assembly gripper 16.

Except for the control rod gripper, the telescope elements are preferably designed as hollow bodies with a square cross-sectional area. The guide mast 12, which can also have a round cross-sectional area, surrounds the centering bell 14, which in turn surrounds the fuel assembly gripper 16 which finally surrounds the control rod gripper. The interior of the centering bell 14 is dimensioned such that the fuel assembly gripper 16 together with a fuel assembly 10 which is suspended therefrom can be accommodated by the centering bell 14. In the extended state in FIG. 1, the centering bell 14 bears against a lower stop 22 of the guide mast 12. The fuel assembly gripper 16 is designed to accommodate a control element in its interior. The control element generally has approximately the same length as the fuel assembly 10.

A Bowden cable 24 extends inside the telescope-type lifting apparatus 8. The cable 24 can be used to lower or raise the telescope elements. In order to lower the telescope elements, the Bowden cable 24 is extended downward, wherein the telescope elements automatically sink downward on account of their own weight. A lifting unit 26 arranged on the traveling trolley 6 is provided for raising the Bowden cable 24 and the telescope elements. The lifting path of the telescope elements upward and downward is limited in each case by an upper and a lower stop. Guide rollers 28 which prevent the telescope elements from mutual jarring or getting stuck are provided between the guide mast 12 and the centering bell 14 carried in its interior, and if appropriate also between the centering bell 14 and the fuel assembly gripped 16.

The loading machine 2 is, for example in a pressurized-water reactor, arranged inside the containment above the actual reactor or reactor core and is used to move fuel assemblies 10 or core internals within the reactor and within a fuel assembly storage pool (not illustrated here in more detail) for spent fuel assemblies 10. The loading machine 2 is also used to transport fuel assemblies 10 between the reactor and the fuel assembly storage pool. In the case of a fuel assembly exchange, the containment is flooded with water at least between the storage pool and the reactor up to a filling level height F. The fuel assemblies 10 must only be transported below said water level for radiation-engineering reasons. The fuel assemblies 10 are stored within the reactor pool or the storage pool in a storage rack (not illustrated here in more detail) in an upright position, wherein the fuel assembly top fitting 30, which in each case points upward, is designed and constructed such that it can be gripped safely with the gripping apparatus 18 of the fuel assembly gripper 16. Furthermore, a fuel assembly identification number is embossed at the top fitting 30 of the respective fuel assembly 10, which number can be used to uniquely identify the fuel assembly 10.

Inside the storage rack each fuel assembly 10 is assigned a fixed reference position which can be described in the abovementioned horizontal coordinate system by way of two coordinates. However, individual fuel assemblies 10 might be at an angle in the storage rack, for example because the respective fuel assembly 10 was originally set down in the storage rack at an angle or because its positional angle has resulted over time from operation-based erosion of the fuel assembly 10. This means that the real actual position of a fuel assembly 10 can deviate more or less significantly from the fixed reference position.

The loading machine 2 is in this invention designed specifically to ensure reliable gripping of a fuel assembly 10 even under such difficult conditions in the context of a largely or completely automated driving mode. For this purpose, a video camera 32 is integrated in the lifting apparatus 8, which camera transmits in real time video images from the reactor pool or the storage pool to a control stand 34 for the loading machine 2. The video camera 32 is housed, for reasons of protection against mechanical effects and, if appropriate, for screening against radioactive radiation, in a protective and guide tube 36 which is fixedly mounted on the outside of the fuel assembly gripper 16, that is to say between the fuel assembly gripper 16 and the centering bell 14. The viewing direction of the video camera 32 is pointed substantially vertically downward, with the result that the horizontal position, which can be varied by way of the position of the traveling bridge 4 and the traveling trolley 6, of the fuel assembly gripper 16 relative to the storage rack which is located thereunder or to the fuel assemblies 10 which are stored in the reactor pool or storage pool can be detected particularly precisely using the video image. The protective and guide tube 36 is aligned substantially parallel to the longitudinal extent of the fuel assembly gripper 16, wherein the lower end of the protective and guide tube 36 is located just above the gripper apparatus 18. The protective tube 36 extends upward up to the upper end of the fuel assembly gripper. For the purposes of good oversight over the gripping region in the area surrounding the gripping apparatus 18, the protective tube 36 can be slightly tilted with respect to the vertical (if appropriate only in its lower section).

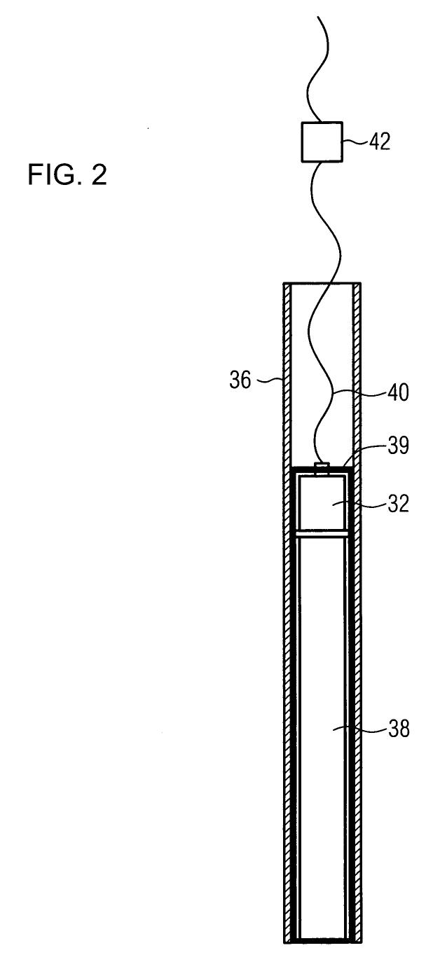

FIG. 2 shows, in detail, a longitudinal section through the protective and guide tube 36 with the video camera 32. For the purpose of a particularly effective protection against radioactive radiation which could, under certain circumstances, adversely affect the operation of the video camera 32, the video camera 32 is arranged relative far up in the protective and guide tube 36, with the result that even during a gripping process a distance which is expedient for the protection of the video camera 32 is observed between said video camera and the respective fuel assembly 10. In order to nevertheless enable a good view downward, which is not obstructed by the walls of the protective and guide tube 36, an endoscope 38 in the form of a rigid lens endoscope is arranged between the objective lens of the video camera 32 and the lower end of the protective tube 36. Furthermore, luminous means (not illustrated here in more detail) which can be integrated in the endoscope 38 or in the video camera 32 are provided for lighting the gripping region. For the purpose of particularly simple exchangeability of the entire camera unit, the video camera 32 and the endoscope 38 are arranged in a metallic internal tube 39 which can be pulled out and removed from above from the protective and guide tube 36 as needed. The video camera 32 is encapsulated in a water-tight manner in the internal tube 39, wherein the closure at the lower end is effected by the endoscope 38 and at the upper end by a closure cap or the like.

Connected to the video camera 32 is a communication line 40 which on the one hand is used for the electric supply and for transmitting control signals to the video camera 32, and which is used on the other hand to transmit the video signals of the video camera 32 via an adapter 42 to the control stand 34 of the loading machine 2. The supply of the luminous means can likewise be effected via the communication line 40, which is carried inside the lifting apparatus 8 and flexibly molds itself to the variable lifting path of the telescope elements.

The control stand 34 of the loading machine 2 comprises, as illustrated schematically in a block diagram in FIG. 1, a display monitor 44 for the video signals transmitted by the video camera 32 and an electronic data processing system 52 having an image processing module 46, a memory module and a control module 50. The image processing module 46 is connected, like the display monitor 44, on the input side to the video output of the video camera 32 via the communication line 40 and automatically recognizes using so-called “image processing software” the position of the fuel assembly gripper 16 relative to a fuel assembly 10 which is located thereunder. The information obtained in this manner is converted into control signals for the loading machine, in particular for the traveling bridge 4 and the traveling trolley 6, in a control module 50 which is connected downstream of the image processing module 46. A manipulated variable sensor integrated in the control module 50 here carries out the driving of the respective drive units, wherein the coordinate system defined by the directions of motion of traveling bridge 4 and traveling trolley 6 are taken as the basis. The control signals are transmitted via the control line 53 from the control module 50 via the operational and safety-related devices to the drive units of traveling trolley 6 and traveling bridge 4.

The image processing module 46 furthermore comprises a pattern recognition module 54 for the automatic recognition and identification of the fuel assembly identification number attached on the top fitting 30 of the respective fuel assembly 10. The image processing module is connected to an administration module (ADMIN) 56 for fuel assemblies 10, in which a step sequence plan for the loading and transport operations to be carried out by the loading machine 2 is stored in electronic form.

In order to remove a specific fuel assembly 10 from the reactor pool or the storage pool, or to remove a control rod or restrictor body arranged in the fuel assembly 10, first the lifting apparatus 8 is brought into a reference position above the fuel assembly 10 to be removed using the traveling bridge 4 and the traveling trolley 6. The associated coordinates are stored in a database of the administration module 56 and are read by the control module 50 and converted into corresponding control signals for the traveling bridge 4 and the traveling trolley 6. Once the reference position is reached, the video image transmitted by the video camera 32 is evaluated by the image processing module 46, wherein any corrections which may be necessary, for example due to a fuel assembly 10 being at an angle or due to permissible tolerances, are automatically ascertained and converted by the control module 50 into control signals. As a result of the feedback provided by the video camera 32 and the image processing module 46, a fully automatic regulating system for the loading machine 2 is realized, which can be interrupted, however, at any time by the loading machine operator who observes the loading processes on the display monitor 44.

Furthermore, the pattern recognition module 54 integrated in the image processing module 46 automatically checks the fuel assembly identification number of the fuel assembly 10 and compares it to the specification of the step sequence plan stored in the administration module 56. Only if they match is the loading process continued by completely setting down the telescope-type lifting apparatus 8 until the centering pins of the centering bell 14 engage in corresponding receivers of the neighboring fuel assembly top fitting (not illustrated here) and thus effects a final “centering” of the gripping apparatus relative to the fuel assembly 10. Finally, the fuel assembly gripper 16 is also lowered until its gripping latches can latch into the top fitting 30 of the fuel assembly 10. The lifting unit 26 is used to lift up the fuel assembly 10 held by the fuel assembly gripper 16 and move it into the centering bell 14. The fuel assembly 10 can then in this transport position be horizontally moved into the reactor well. The fuel assembly 10 can in particular be transported to a fuel assembly storage pool and set down there. When the transport operation is complete, the data base of the administration module 56 is updated correspondingly with the new occupancy layout of the storage rack with fuel assemblies 10.

1. A fuel assembly loading machine, comprising:
a traveling trolley movable about a substantially horizontal plane;
a lifting apparatus including a guide mast anchored to said traveling trolley and a fuel assembly gripper mounted to be extended telescopically from said guide mast;
said fuel assembly gripper being a double gripper having a gripping apparatus at a lower end thereof and a control rod gripper carried in an interior thereof;
a video camera mounted to said fuel assembly gripper, said video camera being pointed in a downward viewing direction and being connected in terms of data to a control stand; and
an endoscope disposed between said video camera and the lower end of said fuel assembly gripper; and
an internal tube encasing said video camera and said endoscope and illumination means in a water-tight manner; and
a protective guide tube configured to receive said internal tube for insertion from above.

2. The loading machine according to claim 1, wherein said video camera is disposed to define a field of vision at least partially detecting a gripping region enclosing said gripping apparatus.

3. The loading machine according to claim 1, wherein said video camera includes a converter unit disposed physically separate from a recording optics thereof, wherein the recording optics is disposed at the lower part of said fuel assembly gripper and said converter unit is disposed at a distance above.

4. The loading machine according to claim 1, wherein said endoscope is a rigid endoscope with a lens optics.

5. The loading machine according to claim 1, which comprises illumination means for lighting a gripping region about said gripping apparatus fixed on said lifting apparatus.

6. The loading machine according to claim 5, wherein said illumination means are mounted to said fuel assembly gripper.

7. The loading machine according to claim 1, wherein said protective guide tube is mounted to an exterior of said fuel assembly gripper.

8. The loading machine according to claim 1, which comprises a centering bell forming a telescope element disposed between said guide mast and said fuel assembly gripper.

9. The loading machine according to claim 1, wherein said control stand includes a display monitor for displaying video signals transmitted by said video camera.

10. The loading machine according to claim 9, wherein said control stand further comprises an electronic data processing system.

11. The loading machine according to claim 10, wherein said data processing system includes an image processing module.

12. The loading machine according to claim 11, wherein said image processing module has a data output connected to a control module for controlling a position of said traveling trolley.

13. The loading machine according to claim 12, wherein said traveling trolley is mounted on a traveling bridge and said control module is configured for controlling a position of said traveling bridge and/of said traveling trolley.

14. The loading machine according to claim 11, wherein said image processing module comprises a pattern recognition module configured to recognize and identify identification features affixed to a fuel assembly.

15. The loading machine according to claim 11, wherein said image processing module is connected to an administration module for fuel assemblies.
